(19) United States
(12) Patent Application Publication
(10) Pub. No.: US 2004/0158874 A1
(43) Pub. Date: Aug. 12, 2004

(54) Broadcast reception apparatus, broadcast reception method, program, and storage medium

(75) Inventors: Kenichiro Ono, Kanagawa (JP); Eiichi Matsuzaki, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/762,333

(22) Filed: Jan. 23, 2004

(30) Foreign Application Priority Data
Jan. 27, 2003 (JP) 2003-017259

(51) Int. Cl. H04N 7/173; H04N 7/16; H04N 5/50

(52) U.S. Cl. 725/131; 725/139; 725/151; 348/731

(57) ABSTRACT

When channels include a plurality of channels, which have the same lineups of programs to be broadcasted in a predetermined time band, a system controller (11) makes display control for displaying, on a display (7), information indicating programs to be broadcasted by one of the plurality of channels in place of the plurality of channels.

### FIELD OF THE INVENTION

The present invention relates to a broadcast reception technique for displaying a list of information indicating respective programs broadcasted for respective channels.

### BACKGROUND OF THE INVENTION

In recent years, as a new television broadcast system, digital broadcast has received a lot of attention. In addition to conventional CS (Communication Satellite) broadcast that uses a communication satellite, BS (Broadcast Satellite) digital broadcast and so-called 110° CS broadcast have started, the number of channels has increased, and the number or programs that viewers can select has also increased. In the future, digital terrestrial broadcast is scheduled to start, and the number of programs may become too large for viewers to select a program.

In digital broadcast, information such as text data, graphic data, and the like can be multiplexed and transmitted to viewers' televisions in addition to conventional video/audio information. Hence, in order to facilitate selection of a program from many programs, information called an EPG (Electronic Program Guide) that allows a viewer to select a program on the display screen of his or her television is transmitted from a broadcast station to the viewer's television while being multiplexed on a broadcast program signal. This EPG is information used to generate a program guide. A digital broadcast reception apparatus equipped in the viewer's television displays an EPG window as a window, which allows the viewer to select a program on the display screen of his or her television, on the display screen on the basis of this EPG. However, a window to be actually displayed differs depending on the television manufacturers and models.

FIG. 10 shows an example of the display screen that includes the EPG window. Reference numeral 80 denotes a display screen of a television. On the display screen 80, a reduced-scale window 81 of a program that the viewer watched so far, a remote-controller guide window 82, and an EPG window 83 are displayed. FIG. 11 shows details of the EPG window 83. FIG. 11 shows titles of programs which BS Yokohama and Kanto BS TV start broadcasting from 7:00, those which they start broadcasting from 8:00, and those which they start broadcasting from 9:00. BS Yokohama is broadcasted using two channels (BS210, BS211). Respective channels are assigned service_id data. Hence, on the EPG window in FIG. 11, the titles of programs with identical service_id data are displayed in the order of broadcast start times.

Although digital broadcast has started, the number of households that receive conventional analog broadcast is larger at present. Hence, a technique that combines EPGs of programs by digital broadcast and those by analog broadcast, and displays an EPG window of program by both the broadcast systems has been disclosed as a prior art (Japanese Patent Laid-Open No. 2000-324410).

In terrestrial broadcast, different broadcast stations (e.g., NHK Osaka and NHK Kyoto) often broadcast an identical program. In such case, a reception device that does not display the contents of identical programs by appending a list of broadcast stations which broadcast identical programs to an EPG upon broadcasting has been disclosed as a prior art (Japanese Patent Laid-Open No. 2000-4426).

According to the EPG window shown in FIG. 11, BS210 and BS211 are channels which are designated by different service_id data. However, since these channels are used by BS Yokohama as a single broadcast station, identical programs are broadcasted in respective time bands. In this manner, when a single broadcast station broadcasts identical programs at identical times using a plurality of channels, different service_id data do not influence viewing or program recording of the broadcast contents. That is, since such different service_id data do not make sense for viewers, identical contents need not be displayed in such case.

Japanese Patent Laid-Open No. 2000-324410 discloses only the technique that combines and displays an EPG, but does not disclose any technique associated with a viewing/program recording function of programs using the EPG.

When the list of broadcast stations that broadcast identical programs to the EPG is appended upon broadcasting as in the technique disclosed in Japanese Patent Laid-Open No. 2000-4426, the broadcast station must prepare such list in advance.

### SUMMARY OF THE INVENTION

The present invention has been made in consideration of the above programs, and has as its object to provide a broadcast reception technique which displays, on a display unit, information indicating programs to be broadcasted by one of a plurality of channels, which have the same lineups of programs to be broadcasted in a predetermined time band, in place of the plurality of channels, of respective channels.

In order to achieve the above object, for example, a broadcast reception apparatus of the present invention comprises the following arrangement.

That is, a broadcast reception apparatus which comprises a reception unit for receiving program information of programs to be broadcasted by respective channels in respective time bands from an external apparatus, and a display unit for displaying a list of information indicating programs to be broadcasted for respective channels on the basis of the program information, characterized by comprising:

display control means for, when the channels include a plurality of channels, which have the same lineups of programs to be broadcasted in a predetermined time band, making display control for displaying information indicating programs to be broadcasted by one of the plurality of channels on the display unit in place of the plurality of channels.

In order to achieve the above object, for example, a broadcast reception method of the present invention comprises the following arrangement.

That is, a broadcast reception method to be executed by a broadcast reception apparatus which comprises a reception unit for receiving program information of programs to be broadcasted by respective channels in respective time bands from an external apparatus, and a display unit for displaying a list of information indicating programs to be broadcasted for respective channels on the basis of the program information, characterized by comprising:

a display control step of making, when the channels include a plurality of channels, which have the same lineups of programs to be broadcasted in a predetermined time band, display control for displaying information indicating programs to be broadcasted by one of the plurality of channels on the display unit in place of the plurality of channels.

In order to achieve the above object, for example, a program of the present invention comprises the following arrangement.

That is, a program characterized by making a broadcast reception apparatus, which comprises a reception unit for receiving program information of programs to be broadcasted by respective channels in respective time bands from an external apparatus, and a display unit for displaying a list of information indicating programs to be broadcasted for respective channels on the basis of the program information, execute:

a display control step of making, when the channels include a plurality of channels, which have the same lineups of programs to be broadcasted in a predetermined time band, display control for displaying information indicating programs to be broadcasted by one of the plurality of channels on the display unit in place of the plurality of channels.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 shows a display example of an EPG video by a broadcast reception apparatus according to the first embodiment of the present invention;

FIG. 2 is a block diagram showing the basic arrangement of the broadcast reception apparatus according to the first embodiment of the present invention, which can receive digital broadcast alone;

FIG. 3 is a schematic view showing the configuration of an EIT;

FIG. 4 is a flow chart of processes executed when the broadcast reception apparatus according to the first embodiment of the present invention displays an EPG window;

FIG. 5 is a block diagram showing the basic arrangement of a broadcast reception apparatus according to the second embodiment of the present invention;

FIG. 6A is a flow chart of processes executed when the broadcast reception apparatus according to the second embodiment of the present invention, which can receive both analog broadcast and digital broadcast, generates EPG data;

FIG. 6B is a flow chart of processes executed when the broadcast reception apparatus according to the second embodiment of the present invention, which can receive both analog broadcast and digital broadcast, generates EPG data;

FIG. 7A is a view for explaining a case wherein the user selects a program [Drama “Daikoku-Futo”] that starts from 9:00 of “BS Yokohama” on the EPG window of digital broadcast so as to make a reservation for viewing or program recording of that program;

FIG. 7B shows a display example in step S74;

FIG. 8 is a flow chart of processes to be executed by a broadcast reception apparatus according to the third embodiment of the present invention;

FIG. 9 shows a display example of an EPG window by the broadcast reception apparatus according to the third embodiment of the present invention;

FIG. 10 shows an example of the display screen that includes a conventional EPG window;

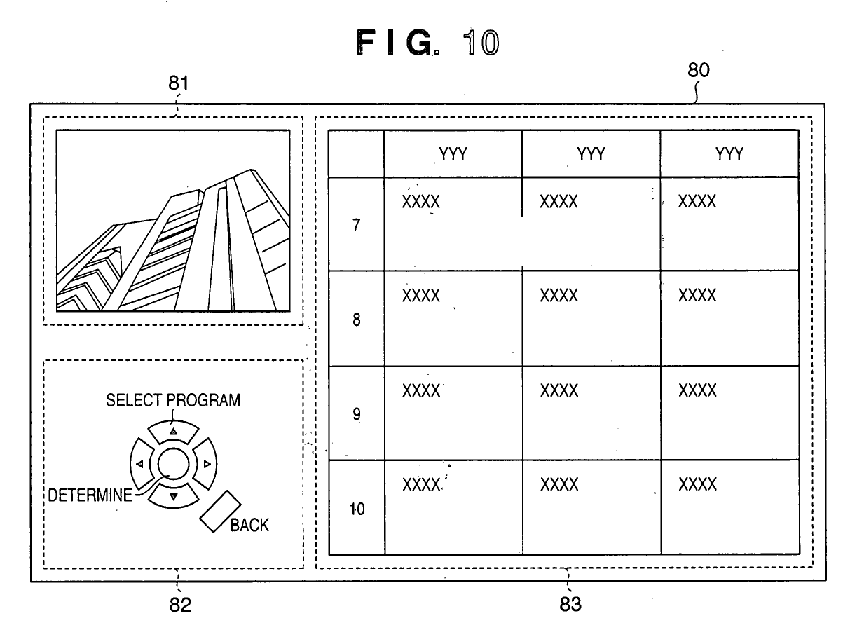

FIG. 11 shows details of an EPG window 83 shown in FIG. 10; and

FIG. 12 is a schematic view showing the configuration of an EPG.

### DETAILED DESCRIPTION OF THE PREFERRED EMBODIMENTS

Preferred embodiments of the present invention will now be described in detail in accordance with the accompanying drawings.

[First Embodiment]

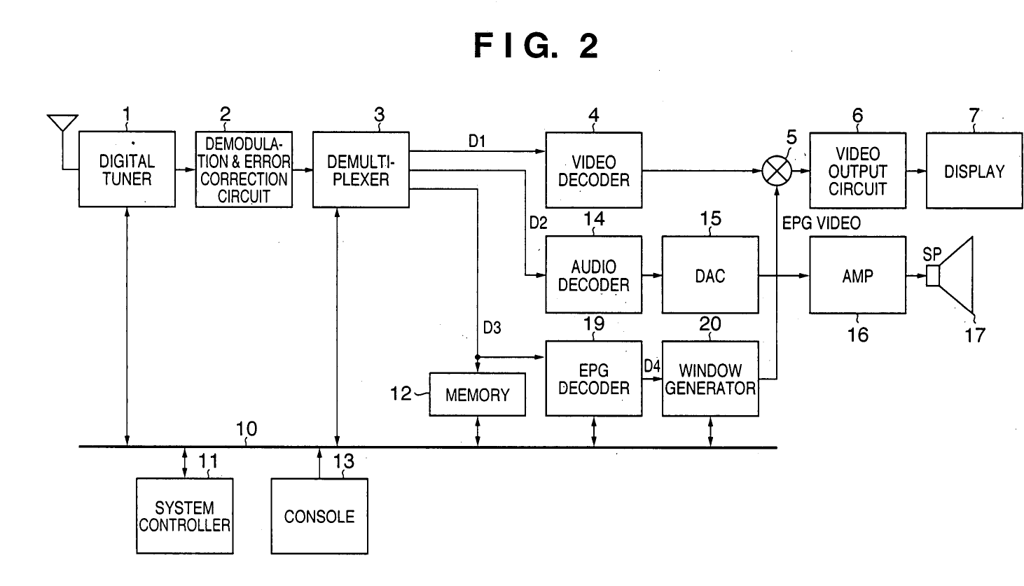

FIG. 2 is a block diagram showing the basic arrangement of a broadcast reception apparatus according to this embodiment, which can receive digital broadcast alone. Reference numeral 11 denotes a system controller which controls the overall digital broadcast reception apparatus; and 10, a bus which connects the system controller 11 and respective circuits to be described later.

A digital tuner 1 receives a digital broadcast wave, and selects a desired frequency in accordance with an instruction from the system controller 11. A signal output from the digital tuner 1 is input to a demodulation & error correction circuit 2, which demodulates the input signal and detects and corrects any errors that may have occurred in a communication path, thus generating digital data in a format called a transport stream.

The generated transport stream is sent to a demultiplexer 3, which specifies a desired video stream D1, audio stream D2, and EPG data D3 from the transport stream on the basis of a control signal from the system controller 11, and outputs them to a video decoder 4, an audio decoder 14, and a memory 12 and EPG decoder 19, respectively.

The video stream D1 signal output from the demultiplexer 3 is decoded according to MPEG2 by the video decoder 4 to obtain a non-compressed video signal. A composition circuit 5 composites the video signal decoded by the video decoder 4, and an EPG video signal generated by a window generator 20 (to be described later), and outputs the composite signal to a video output circuit 6. The video output circuit 6 converts the input composite signal into a signal suited to a display 7 (e.g., a CRT or the like), and displays a video according to the composite signal on the display 7.

On the other hand, the audio stream D2 signal output from the demultiplexer 3 is decoded according to MPEG2 by the audio decoder 14 to obtain a non-compressed audio signal. The decoded audio signal is converted into an analog signal by a digital-to-analog converter (DAC) 15, and that analog signal is amplified by an amplifier 16. A loudspeaker (SP) 17 outputs a sound according to the amplified audio signal.

A console 13 is an I/F device which is comprised of switches, which are used by the user to input a channel switch instruction, EPG window display instruction, and the like to the digital broadcast reception apparatus. Note that the console 13 may be a device directly connected to the bus 10, or a remote controller which wirelessly sends instructions to the bus 10. In this case, a reception unit for wirelessly receiving instructions must be connected to the bus 10.

The process executed by the digital broadcast reception apparatus with the above arrangement using the EPG data will be explained below. The EPG data includes SDT (Service Description Table) data including the names of organization channels, the names of broadcast service providers, and the like EIT (Event Information Table) data indicating programs which are scheduled to be broadcasted, TOT (Time Offset Table) data indicating the current date and time, and the like.

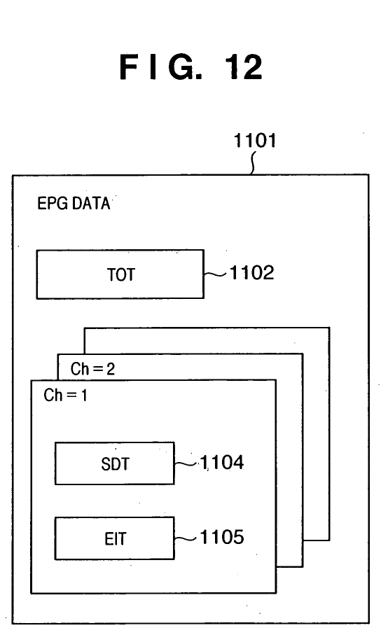

FIG. 12 is a schematic view showing the configuration. of the EPG. EPG data 1101 contains TOT data 1102, SDT data 1104, and EIT data 1105, as described above, and the SDT data 1104 and EIT data 1105 are held to be interrelated for each channel. For example, sets of SDT and EIT data are held for respective channel (like a set of SDT and EIT data for channel 1 (ch=1), that for channel 2 (ch=2), and so forth). Since the sets of SDT and EIT data are held for respective channel, taking channel 1 as an example, information that pertains to all programs broadcasted by channel 1, a broadcast station that broadcasts programs by channel 1, the channel name of channel 1, and the like can be recognized with reference to the set corresponding to channel 1.

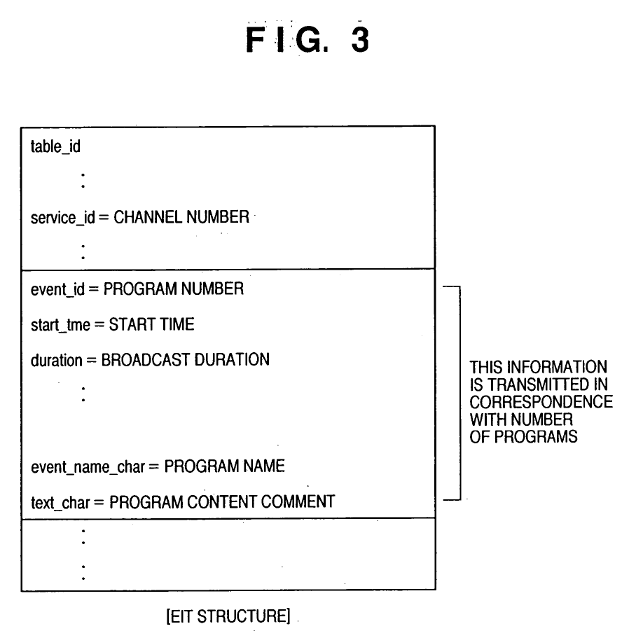

FIG. 3 is a schematic view showing the configuration of an EIT. As described above, FIG. 3 shows an EIT corresponding to one channel.

The EIT contains Service_id data (corresponding to ch in the example shown in FIG. 12) indicating a channel number. Also, the EIT contains sets of event_id data as numbers assigned to programs which are scheduled to be broadcasted by the channel indicated by the Service_id data, start_time data as information indicating the broadcast start times of these programs, duration data as information indicating the broadcast durations, event_name_char data as information indicating program titles, and text_char data as information indicating comments of the program contents in correspondence with the number of programs to be broadcasted by the channel indicated by the Service_id data. Hence, by looking up the EIT data, the titles, broadcast start times, and the like of programs to be broadcasted by each channel can be recognized.

An EPG window displays channel names included in the SDT data, and service_id data, broadcast start time data, program title data, and program content comment data contained in the EIT data in accordance with their broadcast start times on the basis of the current time contained in the TOT data.

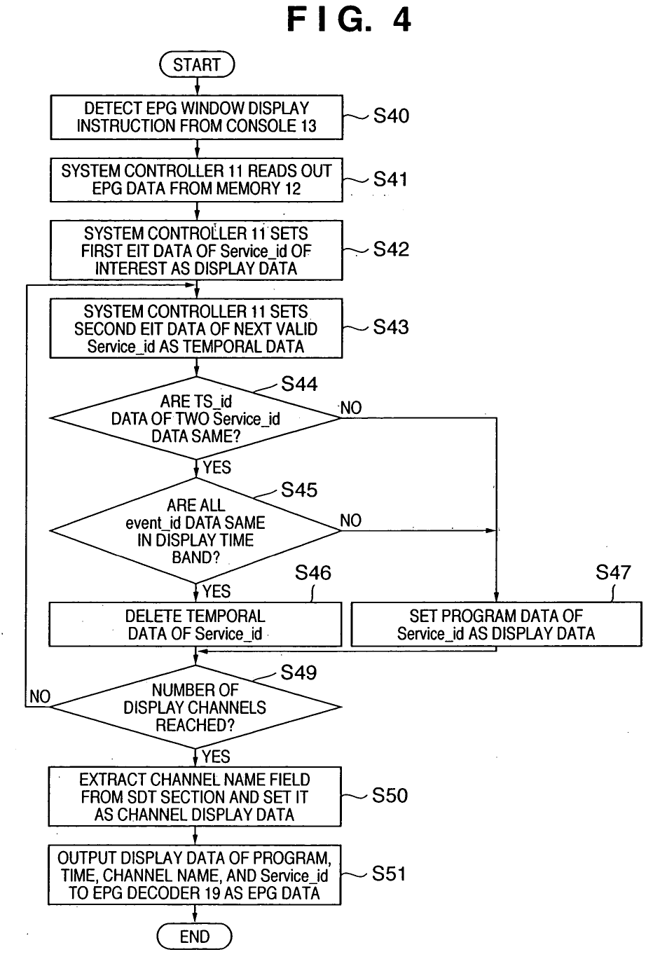

The processes to be executed when the digital broadcast reception apparatus according to this embodiment displays the EPG window will be described below using FIG. 4 which is a flow chart of these processes.

Since the digital tuner 1 always receives a digital broadcast wave, the digital tuner 1, demodulation & error correction circuit 2, and demultiplexer 3 always perform the aforementioned operations. The system controller 11 executes a process for holding EPG data D3 periodically output from the demultiplexer 3 in the memory 12, so as to respond to an EPG window display instruction input from the console 13 as soon as possible.

Upon detection of the EPG window display instruction input from the console 13 (step S40), the system controller 11 reads out the latest EPG data D3 held in advance in the memory 12 from the memory 12 (step S41). The system controller 11 extracts only programs to be broadcasted within a predetermined period of time (display time band) from the current time as those to be processed in the subsequent steps with reference to information indicating the current time in TOT data contained in the readout EPG data D3. For example, if the current time is 7:28, the system controller 11 extracts programs for three hours (7:00 to 9:00) as those to be processed in the subsequent steps.

The system controller 11 sets EIT data (first EIT data) specified by the first valid Service_id (Service_id of interest) as data to be displayed (display data) (step S42). The valid Service_id indicates a channel number assigned to each EIT having the configuration shown in FIG. 3. Note that Service_id of interest is that corresponding to the currently received channel. Furthermore, the system controller 11 sets EIT data (second EIT data) specified by the next valid Service_id as temporal data (step S43).

The system controller 11 then compares data (TS_id) which is contained in SDT data that forms a set with the first EIT data, and indicates an organization channel name, broadcast service provider name, and the like with TS_id of SDT data which forms a set with the second EIT data, so as to determine whether or not the organization channel name, broadcast service provider (broadcast station) name, and the like of the Service_id of the first EIT data are the same as those of the Service_id of the second EIT data (step S44).

If the two TS_id data are different, since the two Service_id data correspond to different organization channel names and broadcast service providers (broadcast stations), the system controller 11 sets respective pieces of information contained in the second EIT data, i.e., the Service_id of interest, broadcast start times, program titles, and program content comments as data to be displayed (step S47).

If the two TS_id data are equal to each other, since the two Service_id data correspond to an identical organization channel name and broadcast service provider (broadcast station), the system controller 11 checks if programs to be broadcasted within the display time band by channels corresponding to these Service_id data have the same lineup (step S45).

More specifically, the system controller 11 compares the lineup of event_id data within the display time band, which are contained in the first EIT data, with that of event_id data within the display time band, which are contained in the second EIT data. If the first and second EIT data have different lineups of event_id data within the display time band, it means that different programs are to be broadcasted by respective channels within the display time band although they are provided by the identical organization channel name and broadcast service provider (broadcast station). Hence, the system controller 11 sets respective pieces of information contained in.the second EIT data, i.e., the Service_id of interest, broadcast start times, program titles, and program content comments as data to be displayed (step S47).

Note that in step S45 when the lineups of event_id data within the display time band, which are contained in the first and second EIT data, have at least one different event_id data, the flow advances to step S47.

On the other hand, if the first and second EIT data have the same lineup of event_id data within the display time band, since these EIT data correspond to an identical organization channel name and broadcast service provider (broadcast station), and identical programs are broadcasted by these channels within the display time band, the system controller 11 deletes the temporal data from the memory 12 (step S46). When EIT data is deleted, since the corresponding SDT data also becomes unnecessary, the SDT data may be further deleted in this step.

Note that a process for comparing start_time data within the display time band, which are contained in the first EIT data, with those within the display time band, which are contained in the second EIT data may be added to the processes in steps S44 and S45 so as to improve the determination precision as to whether or not two channels (the channels corresponding to Service_id data contained in the first and second EIT data) broadcast identical programs.

The system controller 11 repeats the aforementioned processes in steps S43 to S47 for all the channels (step S49). The system controller 11 adds a channel name to the data to be displayed with reference to SDT data which forms a set with the EIT data that remains stored in the memory 12 as data to be displayed (step S50).

The system controller 11 outputs respective display data (program titles, times, channel names, and Service_id data) as the data to be displayed to the EPG decoder 19 as EPG data (step S51).

The EPG decoder 19 decodes the display data (program titles, times, channel names, and Service_id data) selected from the memory 12 by the above processes, and outputs decoded EPG data D4 to the window generator 20. The window generator 20 outputs character signals used to form an EPG to the composition circuit 5 on the basis of the EPG data D4. The composition circuit 5 composites the non-compressed video signal output from the video decoder 4 and the character signals output from the window generator 20, and outputs a composite signal as the composition result to the video output circuit 6. The composite signal is displayed on the display 7 as an EPG video via the video output circuit 6.

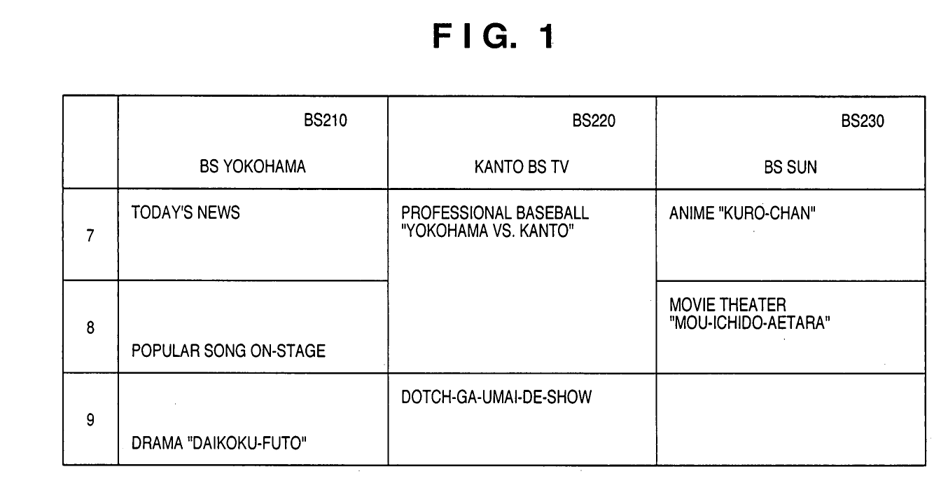

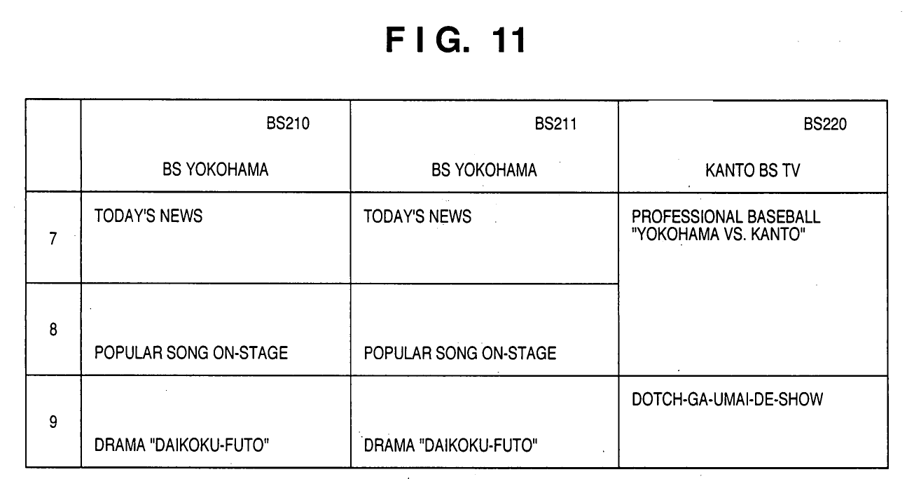

FIG. 1 shows a display example of this EPG video. Service_id data (BS210, BS220, BS230), and channel names are displayed in the uppermost row, and the currently received channel is displayed in the leftmost column. On the display window shown in FIG. 11, programs to be broadcasted by BS Yokohama are redundantly displayed since they are broadcasted by two channels. However, on the display window shown in FIG. 1, since only one (BS210) of BS210 and BS211 is displayed on the display window shown in FIG. 1, only channels which are free from any redundancy in programs to be broadcasted within the display time band can be displayed.

Note that the above process omits display of the titles and broadcast times of programs to be broadcasted by a channel having the same lineup of programs to be broadcasted by the currently received channel within the display time band. By repeating the processes in steps S42 to S49 for all combinations of Service_id data, channels which are free from any redundancy in programs to be broadcasted within the display time band can be displayed for all channels.

Hence, since the broadcast reception apparatus according to this embodiment does not display channels having the same program contents, and can display extra channels accordingly, a larger number of pieces of information useful for the user can be provided at one time, and the user can easily select a desired program without scrolling a program guide.

[Second Embodiment]

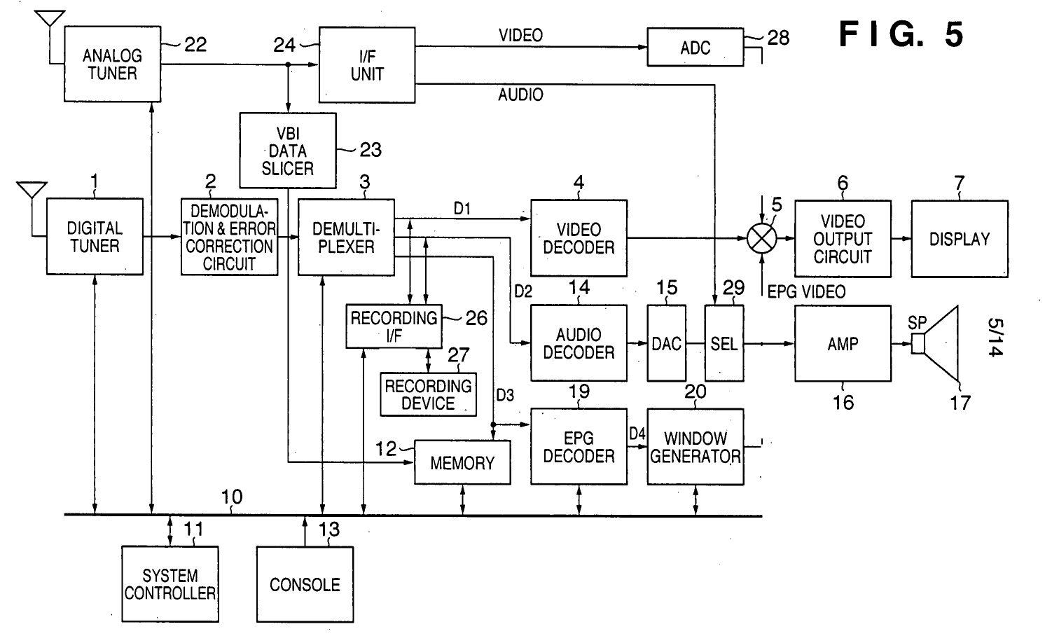

A broadcast reception apparatus according to this embodiment receives analog broadcast in addition to the first embodiment. FIG. 5 is a block diagram showing the basic arrangement of the broadcast reception apparatus according to this embodiment. The same reference numerals in FIG. 5 denote the same parts as in FIG. 2, and a description thereof will be omitted. In data broadcast of analog broadcast, a VBI (Vertical Blanking Interval) scheme that multiplexes and transmits data in a field that does not influence a video of horizontal scan lines is known.

Reference numeral 22 denotes an analog tuner which can receive a VHF analog television broadcast wave, and sends a demodulated signal to an I/F unit 24 that implements an IF amplification & YC separation function. The I/F unit 24 outputs a video signal and audio signal. The video signal is converted into a digital signal by an analog-to-digital converter (ADC) 28, and the digital signal is sent to the composition circuit 5. The composition circuit 5 composites the video signal from the video decoder 4 or the video signal from the analog tuner 22 with an EPG video signal from the window generator 20, and displays a composite signal on the display 7 via the video output circuit 6.

A selector (SEL) 29 selects one of the audio signal from the I/F unit 24 and the audio signal from the DAC 15, and outputs the selected audio signal to the amplifier 16. The amplifier 16 amplifies the input audio signal, and outputs that signal to the loudspeaker 17, which outputs a sound in accordance with the amplified audio signal.

The demodulated signal from the analog tuner 22 is also sent to a VBI data slicer 23. The VBI data slicer 23 extracts VBI data that contains EPG data from the demodulated signal, and stores the extracted data in the memory 12. Assume that the digital tuner 1 receives BS digital broadcast. That is, the broadcast reception apparatus according to this embodiment can receive VHF analog broadcast, and BS digital broadcast.

A recording I/F 26 fetches a video stream D1 and audio stream D2 from the demultiplexer 3 in accordance with an instruction from the system controller 11, and records them on a recording device 27 which comprises a large-capacity storage device such as a hard disk or the like. The data stored in the recording device 27 are output from the recording I/F 26 as a video stream D1 and audio stream D2 in accordance with an instruction from the system controller 11, and undergo the same process as in the first embodiment to allow the user to enjoy them as a video and audio. Furthermore, the broadcast reception apparatus according to this embodiment allows the user to make reservation for viewing or program recording of a program via an EPG window, and video and audio data are recorded on this recording device 27. Reservation information, i.e., the channel number of a program to be reserved, reservation start time, reservation end time, and the like are also recorded in the recording device 27.

The EPG data contained in the VBI data contains a channel number, channel name, start times, broadcast durations, program titles, program content comments, and the like. In analog broadcast, different channels never broadcast identical programs unlike in digital broadcast. These contents of the EPG data of analog broadcast are substantially equivalent to the service provider name, channel number=service_id, program number=event_id, start times, broadcast durations, program titles, and program content comments as the EPG data of digital broadcast described in the first embodiment, except for the presence/absence of the program number. If no program number is available, an EPG window can be generated without any problems.

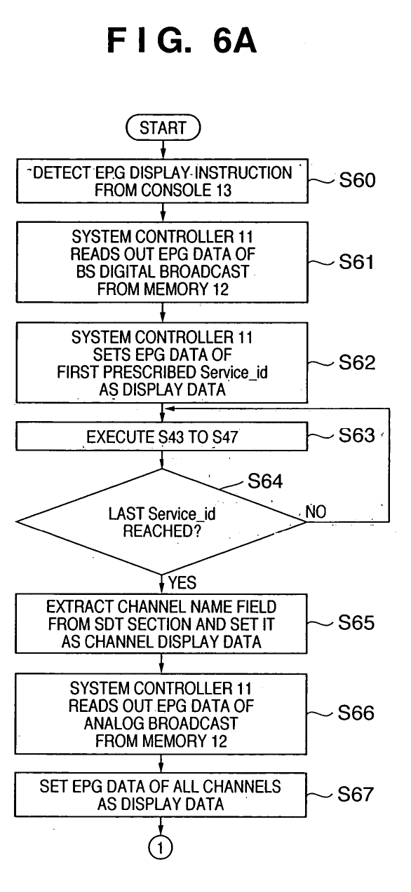

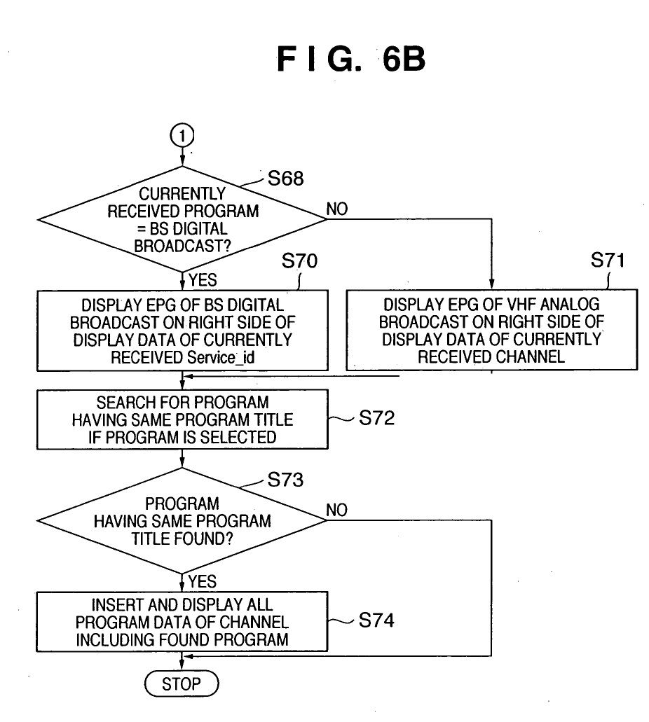

FIGS. 6A and 6B are flow charts of the processes to be executed when the broadcast reception apparatus which can receive analog broadcast and digital broadcast generates EPG data.

Upon detection of the EPG window display instruction input from the console 13 (step S60), the system controller 11 reads out the latest EPG data D3 of digital broadcast held in advance in the memory 12 from it (step S61). The system controller 11 extracts only programs to be broadcasted within a predetermined period of time (display time band) from the current time as those to be processed in the subsequent steps with reference to information indicating the current time in TOT data contained in the readout EPG data D3. For example, if the current time is 7:28, the system controller 11 extracts programs for three hours (7:00 to 9:00) as those to be processed in the subsequent steps (step S62).

Next, the system controller 11 repeats the processes in steps S43 to S47 in the flow chart shown in FIG. 4 until the last Service_id is reached (step S63, step S64). With the above processes, since EPG data to be displayed can be specified, the system controller 11 adds channel names to the data to be displayed with reference to SDT data which form a set with the EPG data to be displayed (step S65).

The system controller 11 reads out EPG data of analog broadcast held in advance in the memory 12 from the memory 12 (step S66). The system controller 11 sets EPG data for all channels as data to be displayed (step S67). Processes in step S68 and subsequent steps are shown in FIG. 6B.

Referring to FIG. 6B, the system controller 11 determines if the currently received program is that of BS digital broadcast (step S68). If the currently received program is that of BS digital broadcast, the flow advances to step S70. The system controller 11 outputs display data (program titles, times, channel name, and service id) of the currently received service_id or of another service_id of the currently received TS_id as EPG data to the EPG decoder 19 for channels to be displayed, thus displaying these data on the display 7 (step S70).

On the other hand, if the currently received program is that of VHF analog broadcast, the system controller 11 outputs the currently received display data (program titles, channel names, times, and channel numbers) as EPG data to the EPG decoder 19 for channels to be displayed, thus displaying these data on the display 7 (step S71).

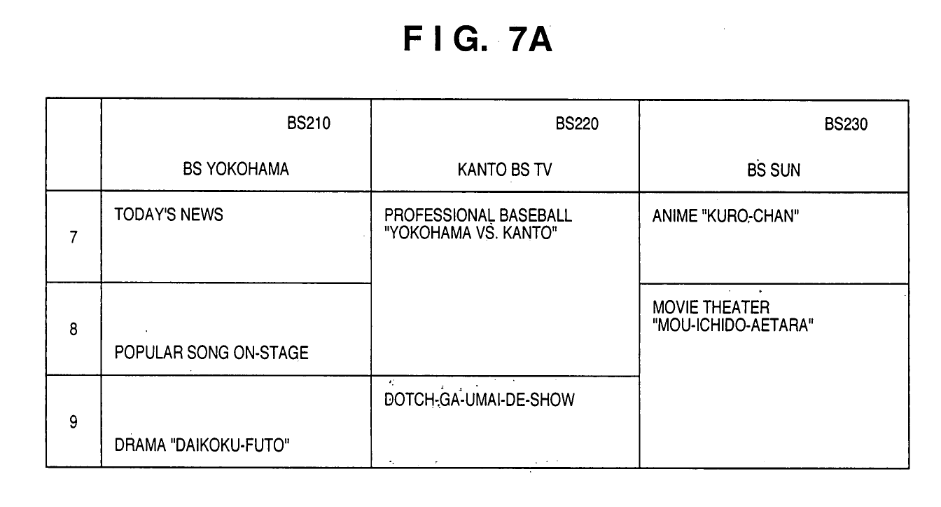

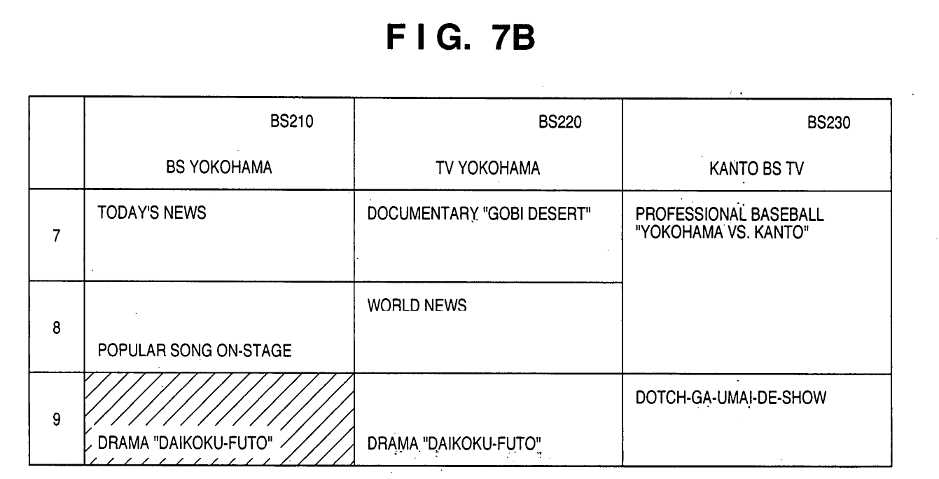

Assume that the user selects a program [drama “Daikoku-Futo”] that starts from 9:00 of “BS Yokohama” on the EPG window of digital broadcast so as to make a reservation for viewing or program recording of that program, as shown in FIG. 7A. Then, EPG data to be displayed, which are processed in steps S65 and S67 are searched for a program having the same program title irrespective of digital or analog broadcast (step S72).

If a channel that broadcast the program of the same program title is found (step S73), the system controller 11 displays all programs to be broadcasted by this channel within the display time band at the left neighboring position of the display position where all programs to be broadcasted by the channel that broadcasts the program selected in step S72 within the display time band (step S74). FIG. 7B shows a display example in step S74.

The display example in FIG. 7B corresponds to FIG. 6B, and since [drama “Daikoku-Futo”] is to be broadcasted at the same time by “TV Yokohama” of analog broadcast, a program guide of “TV Yokohama” is inserted and displayed on the right side of “BS Yokohama”. That is, channels having the same program title are displayed at neighboring positions regardless of the broadcast schemes (digital or analog broadcast). Note that the display position is not limited to such position, and may be a right neighboring position.

Therefore, since the broadcast reception apparatus according to this embodiment displays channels having the same program title at neighboring positions regardless of digital or analog broadcast, program selection is visually facilitated. Furthermore, the user may have wanted to record a given program as an analog video by a VTR (not shown), but later learn that the same program is also broadcasted by digital broadcast in addition to analog broadcast. In such case, since the recording device 27 allows easy reservation for program recording from the EPG window, a reservation operation can be facilitated.

Also, if the user learns that the same program is also broadcasted by digital broadcast in addition to analog broadcast, he or she may decide to view that program as a digital video since digital broadcast has a high image quality but analog broadcast has a standard image quality. Conversely, the user who wanted to view a digital broadcast program may change his or her mind to view an analog broadcast program since he or she wants to make program recording of another digital broadcast program on the recording device 27 in the same time band. In this way, the range of choice of program viewing can be broadened.

[Third Embodiment]

A broadcast reception apparatus according to this embodiment checks whether or not another program has been reserved in the time band in which a program selected for reservation is to be broadcasted, and informs the user of that result, in addition to the process of the broadcast reception apparatus according to the second embodiment.

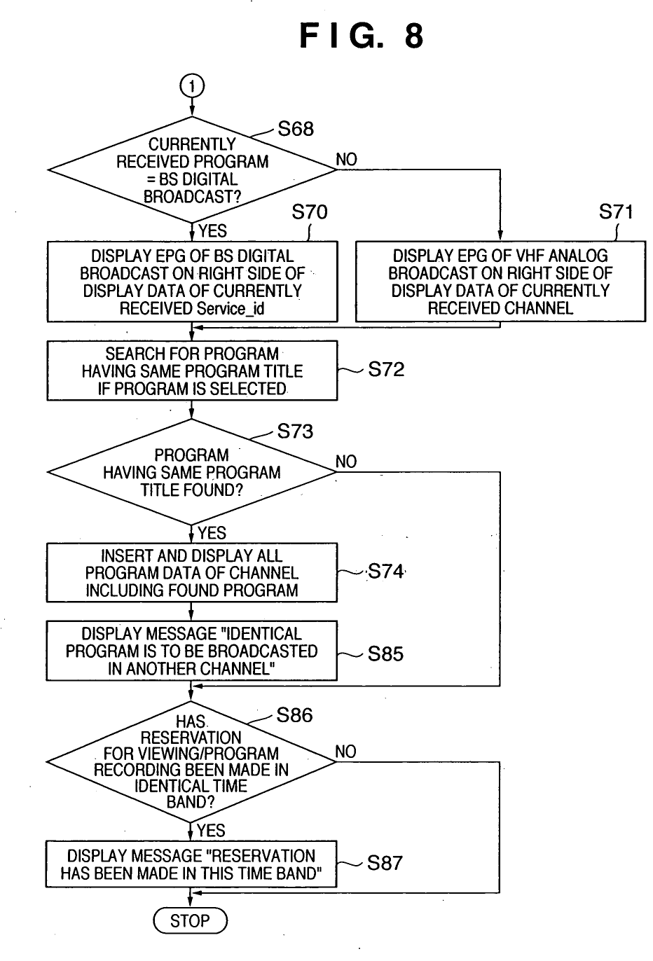

FIG. 8 is a flow chart showing the processes to be executed by the broadcast reception apparatus of this embodiment. As the processes according to the flow chart in FIG. 8, processes in steps S85, S86, and S87 are added to those shown in FIG. 7B. Hence, the same step numbers in FIG. 8 denote the same processes as in FIG. 7B, and a description thereof will be omitted.

If the same information as that indicating the selected program is found in step S73, the system controller 11 sends a message “an identical program is to be broadcasted by another channel” to the window generator 20 after step S74. The window generator 20 displays this message on the EPG window (step S85), and clearly informs the user that the identical program is found.

Since the broadcast reception apparatus according to this embodiment allows reservation for viewing or program recording as in the broadcast reception apparatus according to the second embodiment, the system controller 11 checks if reservation for viewing or program recording has been made in the time band in which the selected program is to be broadcasted (step S86). As for the already reserved program, its channel number, reservation start time, reservation end time, and the like are recorded on the recording device 27. Hence, with reference to such program reservation recording information, whether or not another program has already been reserved in the time band in which the selected program is to be broadcasted can be checked.

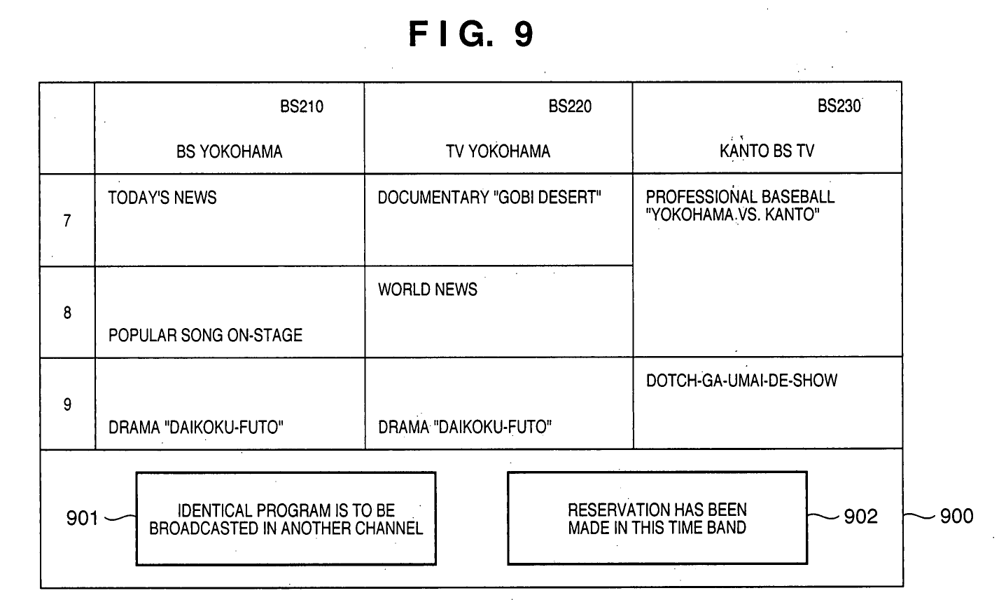

If it is determined in step S86 that another program has already been reserved in the time band in which the selected program is to be broadcasted, the system controller 11 sends a message “reservation has already been made in this time band” to the window generator 20. The window generator 20 displays this message on the EPG window (step S87), and warns the user. FIG. 9 shows a display window example of the display 7 as a result of the above process.

On the window shown in FIG. 9, since the same program as the program selected for reservation ([Drama “Daikoku-Futo”] that starts from 9:00 of “BS Yokohama”) is found in another channel, a message 901 that advises accordingly is displayed on an EPG window 900. In this case, the number of the found channel may be displayed together with the message 901. On the window shown in FIG. 9, since another program has already been reserved in the time band in which the program selected for reservation is to be broadcasted, a message 902 that advises accordingly is displayed on the EPG window 900.

Therefore, since the broadcast reception apparatus according to this embodiment clearly displays messages “an identical program is found” and “reservation has already been made”, the effect of the second embodiment can be further improved.

[Another Embodiment]

The objects of the present invention are also achieved by supplying a storage medium (or recording medium), which records a program code of a software program that can implement the functions of the above-mentioned embodiments to the system or apparatus, and reading out and executing the program code stored in the storage medium by a computer (or a CPU or MPU) of the system or apparatus. In this case, the program code itself read out from the storage medium implements the functions of the above-mentioned embodiments, and the storage medium which stores the program code constitutes the present invention. The functions of the above-mentioned embodiments may be implemented not only by executing the readout program code by the computer but also by some or all of actual processing operations executed by an operating system (OS) running on the computer on the basis of an instruction of the program code.

Furthermore, the functions of the above-mentioned embodiments may be implemented by some or all of actual processing operations executed by a CPU or the like arranged in a function extension card or a function extension unit, which is inserted in or connected to the computer, after the program code read out from the storage medium is written in a memory of the extension card or unit. When the present invention is applied to the storage medium, that storage medium stores the program codes corresponding to the aforementioned flow charts.

As described above, according to the present invention, when channels include a plurality of channels, which have the same lineups of programs to be broadcasted in a predetermined time band, information indicating programs to be broadcasted by one of the plurality of channels can be displayed on the display unit in place of the plurality of channels.

As many apparently widely different embodiments of the present invention can be made without departing from the spirit and scope thereof, it is to be understood that the invention is not limited to the specific embodiments thereof except as defined in the claims.

What is claimed is:

1. A broadcast reception apparatus which comprises a reception unit for receiving program information of programs to be broadcasted by respective channels in respective time bands from an external apparatus, and a display unit for displaying a list of information indicating programs to be broadcasted for respective channels on the basis of the program information, comprising:
display control means for, when the channels include a plurality of channels, which have the same lineups of programs to be broadcasted in a predetermined time band, making display control for displaying information indicating programs to be broadcasted by one of the plurality of channels on the display unit in place of the plurality of channels.

2. The apparatus according to claim 1, further comprising:
designation means for designating one of a plurality of pieces of information which are displayed on the display unit and indicate programs to be broadcasted by respective channels; and
search means for, when information indicating a program is designated by said designation means, searching all pieces of information which are displayed as a list on the display unit and indicate programs for the same information as the designated information, and
wherein that said display control means further makes control for displaying an information group indicating all programs to be broadcasted by a channel that broadcasts a program indicated by the information detected by said search means in the predetermined time band near a display position of a program group to be broadcasted by a channel that broadcasts the program designated by said designation means.

3. The apparatus according to claim 2, wherein when all the pieces of information which are displayed as the list on the display unit and indicate programs include the same information as the information designated by said designation means, said display control means further makes control for displaying a message indicating the presence of that information on the display unit.

4. The apparatus according to claim 3, further comprising:
storage means for storing information previously designated by said designation means, and
in that when information designated by said designation means has already been stored in said storage means, said display control means makes control for displaying a message indicating that storage on the display unit.

5. A broadcast reception method to be executed by a broadcast reception apparatus which comprises a reception unit for receiving program information of programs to be broadcasted by respective channels in respective time bands from an external apparatus, and a display unit for displaying a list of information indicating programs to be broadcasted for respective channels on the basis of the program information, comprising:
a display control step of making, when the channels include a plurality of channels, which have the same lineups of programs to be broadcasted in a predetermined time band, display control for displaying information indicating programs to be broadcasted by one of the plurality of channels on the display unit in place of the plurality of channels.

6. A program characterized by making a broadcast reception apparatus, which comprises a reception unit for receiving program information of programs to be broadcasted by respective channels in respective time bands from an external apparatus, and a display unit for displaying a list of information indicating programs to be broadcasted for respective channels on the basis of the program information, execute:
a display control step of making, when the channels include a plurality of channels, which have the same lineups of programs to be broadcasted in a predetermined time band, display control for displaying information indicating programs to be broadcasted by one of the plurality of channels on the display unit in place of the plurality of channels.

7. A computer readable storage medium characterized by storing a program of claim 6.
